(19) United States
(12) Patent Application Publication
(10) Pub. No.: US 2008/0145640 A1
(43) Pub. Date: Jun. 19, 2008

(54) Removable marking surfaces

(76) Inventor: Michael Jerome Heiman, Lee's Summit, MO (US)

Correspondence Address: MICHAEL HEIMAN, 532 SE, BATTERY DRIVE, LEE'S SUMMIT, MO, 64063-1055, US

(21) Appl. No.: 11/950,681

(22) Filed: Dec. 5, 2007

Related U.S. Application Data
(60) Provisional application No. 60/869,232, filed on Dec. 8, 2006.

(51) Int. Cl. B32B 3/26

(52) U.S. Cl. 428/304.4

(57) ABSTRACT

Surface to remove markings made from, to include but not limited to: dry erase markers, permanent markers, regular markers, pens, crayons, and spray paint. The surface will allow the marking and removal of same, to be used as a wipeable writing surface or as an anti-graffiti surface.

### BACKGROUND OF THE INVENTION

The invention generally relates to articles having a surface that is written upon.

As commonly used, the term “dry erase” refers to items (to include but not limited to markers and writing surfaces) where markings can be erased without adding moisture. These surfaces generally allow the addition of certain wet products to aid in the removal of said markings. In some cases, certain inks are formulated for use on specific dry erase surfaces; but may not be dry erased on other dry erase surfaces.

Ink markers that are formulated as “dry erase” are traditionally used but are not necessarily dry erasable on all dry erase designated products.

In the art, use of some permanent markers, “regular” paper markers, and other ink markers may create fixed marks that are not removable in total or in part without damaging the surface; thereby, rendering the surface blemished. Use of other writing utensils, to include but not limited to, pens, pencils, crayons, and paint (to include but not limited to brush, roller, or spray paints) can also blemish the surface.

Erasable surfaces are commonly applied to substrates that are rigid or flexible; or are made rigid or flexible. Rigid products, sometimes referred to as “dry erase boards” or “whiteboards” range in size from small hand-held size boards to larger boards that are 5 feet tall and 16 feet wide are commonly know in the art as an erasable writing surface. Smaller products limit the writing surface size; while larger rigid products encounter issues of shipability and heavy weights. The application of these writable coatings, that include melamine and porcelain, is usually a paint application. Porcelain and porcelain-type products are often times applied to metal (this also offers the added feature of being a magnetic surface) because of the curing process. Most surfaces on metal substrates are easily dentable and promote cracking and flaking of the surface. Exemplary dry erase boards using cured melamine resins are manufactured by GBC Office Products, Skokie, Ill., Boone International, Corona, Calif., and RoseArt Company, Wood Ridge, N.J. Exemplary dry erase boards using porcelain covered steel are available from Claridge Products and Equipment, Harrison Ark., and Polyvision (a Steelcase company), Suwanee, Ga.

Flexible film is also used to create dry erase surfaces. This product can be rolled in a tubular fashion allowing lengths in excess of 16 feet to be readily shipped in lighter weights. Flexible film can also be easily cut into various shapes. Commercially available flexible dry erase surfaces include fluoropolymer film, vinyl films, and ultraviolet radiation (UV) curable films. Exemplary dry erase articles using fluoropolymer film can be obtained from Walltalkers, Inc., Fairlawn, Ohio. Lacquer, or radiated cured lacquer, is also used as a surface (U.S. Pat. No. 5,037,702 and U.S. Pat. No. 5,024,898 respectively). Exemplary vinyl dry erase articles are sold by Best-Rite Manufacturing, Temple, Tex. Exemplary UV curable hardcoat film dry erase boards are commercially available from General Binding Corporation, Northbrook, Ill. and ACCO World Corporation, Lincolnshire, Ill.

Dry erase surfaces are also otherwise known as white boards due to the coloring of the board. Additional colors are available with tints added. This process significantly raises the cost of the surface due to the limited quantity of surfaces desired in such custom color.

Dyne level is a measurement of surface energy. Standard dyne levels of poly resin films include ranges from 30 to 60 dynes/cm. When substrates are in the range of 10 (ten) or more dynes greater than the dynes of applied markings (example: inks), the markings become harder to remove. Solvents in the surface or in the writings can also modify the surface adjusting the erasability and cleanability of the surface. Natural dyne levels of products can be altered in numerous ways to include but not limited to using corona treatments; certain treatments can be temporary or permenant. Unpolymerised monomer, low molecular weight material, electrical charges, and liquids placed on the surface can also alter the erasability and cleanability of certain surfaces. Some surfaces currently sold in this art increase in difficulty of erasing as the surface is rubbed with an eraser. These surface area charges must discharge by a performed process or over time (usually in minutes or hours depending on the conditions) before the previous ease of erasability returns.

Pore size and surface texture variations are two other main factors affecting the removing of markings from a surface. Markings that enter surface pores or set in ridges can be difficult to remove. This may become apparent in the residual remains of the writings after removal has been attempted. The remains may appear as a full display of the marking or as a ghosting (somewhat diminished image of the original marking) of the original image on the surface. These remnants can become permanent.

Creation of graphs, graphic designs, and verbiage are traditionally placed on top of the surface using markings or tape products. This methodology becomes problematic as the markings and/or tape products wear, become unsightly, or remove in some part from the surface. Some processes allow images to be infused under the surface before the dry erase coating is applied. This remedy has adverse economic results including raising the costs in both time and money; when done individually, the costs quickly become prohibitive for most single unit users.

UV rays can yellow or tarnish exposed surfaces.

Most surfaces designated to remove markings are indoor writing surfaces, not for unprotected use and/or placement outdoors.

Most surfaces in the art allow the use of designated wet materials to assist in the removal of certain markings. However, common sanitation fluids and alcohols, like isopropyl alcohol, can possibly damage some surfaces; thereby, reducing the ability to disinfect and/or sanitize the surface to reduce the spread of germs in environments including, but not limited to, hospitals and schools.

It would therefore be desirable to provide surfaces that allows for a variety of writing surface sizes and shapes; allowing magnetic flow through its surface for use of magnets when applied to appropriate metals without cracking or flaking when the metal is dented; to be easily transported and shipped; that have sustainable or altering dyne levels and minimize pores; have surface ridges so that to remove most markings; remove markings from a wide range of marking utensil manufacturers to include but not limited to: dry erase markings, permanent marker markings, paper “regular” markers markings, crayon markings, pen markings, pencil markings, and paint markings (spray paint and other); a surface that can be colored in appearance or transparent allowing any color or imaging to be seen; protection of same sub-surface imaging, economical (to include but not limited to time and money) allowing graphs, verbiage, graphic designs, and other images to be visible under the surface; UV treatable; that can be used indoors or outdoors; and sustain its cleanability and appearance with the use of a range of speciality-purpose chemicals like disinfectants and/or sanitization solutions.

### BRIEF SUMMARY OF THE INVENTION

The invention is the use of treated, or non-treated based on the article, of products creating or having a dyne level of no more than fifteen (15) dynes above that of the writing instrument (with an optimum dyne variance of no more than ten dynes above that of the writing instrument); and to have a surface with few or non-existent pores and acceptable ridges so as to not to adversely affect the removing of markings of same. Based on the marking instruments, the dyne level of the surface can be set to readily remove permanent marker, dry erase marker, other markers, pens, pencils, dyes, paints, crayons, and other markings. The invention can be colored or transparent allowing color and imaging to be place on the substrate (examples include printing or drawing on vinyl, metal, or wood) and then covered so that the imaging is under the surface protected from damage and/or removal. The invention can have adhesive applied to accommodate installation, be clear, colored, UV treated, be placed over numerous substrates (including, but not limited to, magnetic metals, panels, painted or unpainted walls); products can by dyne appropriate and yet readily cutable to various sizes and shapes. The surface can be used as a cleanable writing surface allowing both dry erase and wet removal of markings to be used as an anti-graffiti surface. The surface can have permanent adhesive, removable adhesive, or no adhesive applied to accommodate the mode of use and application.

### DETAILED DESCRIPTION OF THE INVENTION

Acceptance and removal of markings (whether ink, dye, paint, marker, crayon, wax, lead, or other) on the writing surface whereas the dyne level is at most fifteen (15) dynes, optimally a maximum of 10 (ten) dynes, above the dyne level of the markings. The dyne level can be from a treatment or from a product's natural dyne level. Permanent material dyne levels and permanent dyne level changes in this range will allow for sustained removability, whereas, temporary dyne level adjustments in this range that will adjust beyond this range after a set period of time will allow for limited time for removability of the markings with the markings achieving a level of permanence after the duration of the modified dyne level expires. Temporary removability may be desired in some applications such as art work or work completed in phases where markings on the product may be desirable (to record various information) then removed, whereas the final product is not desired to be marking removable.

A number of products have natural dynes within the acceptable range for use with marking instruments currently available, or can have their dyne levels altered to meet the criteria listed in paragraph 15 above. Polypropylene, one such item, can have a formula where the dyne level is in the range surrounding 32. Typical marker solutions to readily remove from this dyne range include ethanol, ethyl acetate, isopropanol, methyl isobutyl ketone, n-butanol, n-butyl acetate, and n-propanol; where n-butyl acetate has the highest dyne level. The natural dyne level of polypropylene is approximately seven (7) dynes higher than n-butyl acetate, which is below the optimal 10 (ten) dyne variance.

The writing surface should also minimizes the pore size and crevices of the surface. Processes that reduce or eliminates pores and crevices where the markings can be trapped or allowed to pass through will also increase the ease of removing markings as in, but not limited to, filling or stretch blowing.

Pigments and UV treatments that move a product into the desired dyne range or ones that do not alter the dyne level beyond the range can be added to produce surfaces of various colors and UV treatments.

Alternative to color opacity, a certain amount of clarity can be reached with some products which allows the surface to obtain a degree of transparency. This surface can then be placed directly over another surface (examples: board, wall, metal, paper, or vinyl) so that the color and markings on the sub-surface can be seen.

By using a transparent permanent or removable adhesive (whether applied directly to the film or to the sub-surface), the sub-surface colors and markings are then visible through the surface and the adhesive level if adhesives are used. Alternative to transparent adhesives, permanent or removable color adhesives can be used to enhance a surface color appearance.

Numerous adhesives, including acrylic, can be used to attach the writing surface to a substrate and to allow the surface to be used in climate variations that include outdoor use.

The dyne level of the adhesive side of the surface can be raised to more readily hold the adhesive or lowered to create present invention.

A liner can be placed against the adhesive to maintain the adhesive coating until the surface is applied. When the marking removable surface is uncoiled from a roll or removed from a stack and transported, a liner may be desired to maintain the adhesive. A liner may also be desired if the adhesive is applied without significantly varying the dyne level from the top and bottom of the surface to allow the adhesive on a given side not to transfer to the other side of the adjoining surface. In this instance, the release from the liner must be greater than the release from the film so that the adhesive remains on the film and not on the liner.

The product can be readily manufactured to various widths, including traditional widths of 48 inches (122 cm) and 60 inches (152 cm), and to lengths from fractional inches up to several hundred feet or more. The surface can be cut to various lengths and shapes. If the surface is thin enough, the surface can be cut and shaped via a sharp blade or scissors.

The surface can be directly applied to surfaces to include, but not limited to, walls, boards, metal, magnets, magnetic receptive surfaces, refrigerators, doors, and itself. The thickness of the surface may vary to assist in the application and use of same.

Thinner surfaces can be rolled and are therefore easier to transport and ship. This can accommodate long lengths up to hundreds of yards (meters) or longer, readily allowing marking removable surfaces of various lengths.

The surface can also accommodate isopropyl alcohol as a disinfectant/sanitizer to be used on the surface, to include but not limited to, hospitals and schools.

1. From the foregoing, it can be realized that this invention provides a means of producing removable marking surfaces which can be achieved via the determination and/or alteration of the dyne levels of the marking surface to that of the marking; in association with the porosity and smoothness of the surface to meet that of the removal apparatus. This invention allows the use of substrates to become marking removable of other writing instruments other than dry erase designated markers. This invention allows products that possess other desirable attributes to be used as marking removable surfaces including outdoor usage for dry erase writing products. Light opacity to transparent marking removable surfaces can be used so that economic imaging can be made below the surface with readily available printing and imaging methods. This invention allows existing materials, that are preferred based on their use, to become removable surfaces of otherwise permanent markings by the alteration of their dyne level to best meet that of the writing instrument. This invention further allows the use of a surface to move from a removable to permanent (or vice-versa) marking surface by use of the means, and permanency of, the alteration of the surface's dyne level into the desired ranges.

What is claimed:

1. A removable marking surface based on:
Dyne levels in the range of no more than fifteen (15) dynes, optimally a maximum of 10 (ten) dynes, above the dyne level of the markings.
Porosity and smoothness of surface to meet removal apparatus (commonly referred to as an eraser).
Various opacity and transparency to accommodate low economic costs for custom colors, graphics, imaging, and usage.

2. The removable marking surface of claim 1 wherein the dyne level is achieved via unaltered product selection.

3. The removable marking surface of claim 1 wherein the dyne level is permanently achieved via altering the product dyne level with addition of offsetting dyne level products and/or treatments.

4. The removable marking surface of claim 1 wherein the dyne level is temporarily achieved via altering the product dyne level with addition of offsetting dyne level products and/or treatments.

5. The removable marking surface of claim 1 wherein the porosity and smoothness of the surface allows for the removal of the markings via the selected removal apparatus.

6. The removable marking surface of claim 5 wherein the removal apparatus is traditionally dry but will also accommodate wet solutions to achieve other additional benefits like sanitation.

7. The removable marking surface of claim 1 wherein the opacity of the surface can be of a high opacity ranging to transparent.

8. The removable marking surface of claim 7 wherein a lower opacity to transparent surface allows for the ability to see the colors and imaging below said surface.

9. The removable marking surface of claim 8 wherein the subsurface and its imaging is protected.

10. The removable marking surface of claim 7 wherein colored or transparent adhesive is used to modify or reinforce the coloring, or lack thereof, of said surface and can also accommodate various climate variations including, but not limited to, outdoor usage.
